(19) United States
(12) Patent Application Publication
(10) Pub. No.: US 2024/0383460 A1
(43) Pub. Date: Nov. 21, 2024

(54) Air-to-Electric Brake Conversion Device, System and Method of Use

(71) Applicant: Michael McCardell, Mechanicsburg, PA (US)

(72) Inventor: Michael McCardell, Mechanicsburg, PA (US)

(21) Appl. No.: 18/419,613

(22) Filed: Jan. 23, 2024

Related U.S. Application Data
(60) Provisional application No. 63/502,226, filed on May 15, 2023.

(51) Int. Cl. B60T 13/58; B60T 13/24; B60T 13/74; B60T 17/04

(52) U.S. Cl. CPC B60T 13/58; B60T 13/74; B60T 17/043; B60T 13/24

(57) ABSTRACT

A semi-truck to RV conversion device and system is disclosed. The device has a weatherproof electrical enclosure mounted on a semi-truck, which can be attached permanently or removably via, for example, an adjustable strap and fastener. The conversion device features gladhands for connecting to the truck's air lines, a semi-truck light cord plug-in, and an RV-style light cord plug-in for integrating the truck's lighting system with the trailer. The system also incorporates an air-to-electric brake controller that converts air pressure from the truck's braking system into electrical signals to control the trailer's electric brakes, with the braking force on the trailer being proportionate to the air pressure signal for synchronized braking. This system improves safety and enables for quick transitions between hauling different types of trailers.

### CROSS-REFERENCE TO RELATED APPLICATION

The present application claims priority to, and the benefit of, U.S. Provisional Application No. 63/502,226, which was filed on May 15, 2023, and is incorporated herein by reference in its entirety.

### FIELD OF THE INVENTION

The present invention generally relates to the field of braking devices. More specifically, the present invention relates to a novel air-to-electric brake conversion system for semi-trucks, enabling trucks with air brakes to tow trailers with electric brakes. The system has an electrical enclosure mounted on a semi-truck, features gladhands for connecting to the truck's air lines, a semi-truck light cord plug-in, and an RV-style light cord plug-in for integrating the truck's lighting system with the trailer. An air-to-electric brake controller is disposed inside the cab of the semi-truck to work with the device. Accordingly, the present disclosure makes specific reference thereto. Nonetheless, it is to be appreciated that aspects of the present invention are also equally applicable to other like applications, devices, and methods of manufacture.

### BACKGROUND

By way of background, semi-trucks and other heavy over the road vehicles commonly use air brake systems. The air brake systems use compressed air to create the force required to apply the brakes. Air brakes are used as they are efficient and reliable for heavy vehicles. Some trailers, like many RVs or gooseneck trailers, use electric brakes. The electric brake system relies on an electrical signal to engage the brakes. Since semi-trucks use air brakes and some trailers use electric brakes, a conversion adapter is used to translate the air brake signals from the truck into electrical signals to activate the trailer's electric brakes. Generally, a 7-pin round connector is used on commercial vehicles, including semi-trucks. The 7-pin round connector has seven pins arranged in a circular pattern. A 7-blade connector is often used in RVs and gooseneck trailers, with seven blades in a more rectangular configuration.

A standard adapter makes physical and electrical connections between the semi-truck and trailer but may not facilitate the use of a brake controller with a semi-truck's air brake system. Accordingly, the driver of the semi-truck may not have direct control over the trailer's brakes. Also, when a semi-truck is physically connected to a trailer, the lighting system (such as turn signals and brake lights) may not function as required by the trailer. Commonly, semi-trucks have separate circuits for brake lights and turn signals, and trailers designed for recreational use, often have combined brake lights and turn signal systems. There is a need for an improved brake conversion system that can fully integrate the different functionalities of the truck and trailer braking and lighting systems for safe and efficient towing.

Therefore, there exists a long-felt need in the art for a system that enables semi-trucks, which use air brakes, to tow trailers that have electric brakes. Additionally, there is a long-felt need in the art for an improved braking conversion adapter that translates the air brake signals from the truck into electrical signals that can operate the electric brakes on the trailer. Moreover, there is a long-felt need in the art for a brake conversion system that simplifies the process of towing an RV, work, or similar trailer with a semi-truck. Further, there is a long-felt need in the art for a semi-truck and trailer braking compatibility system that includes red gladhand and blue gladhand. Furthermore, there is a long-felt need in the art for a comprehensive conversion system designed for semi-trucks, enabling the trucks to pull trailers with electric brakes using the truck's air brakes. Finally, there is a long-felt need in the art for a conversion system that integrates air brake signals with electric brake systems and adapts the lighting systems for compatibility with RV-style or work style trailers.

The subject matter disclosed and claimed herein, in one embodiment thereof, comprises a standalone conversion device designed to enable semi-trucks with air brakes to tow trailers with electric brakes. The device comprising a T-shaped, weatherproof electrical enclosure, a base made of steel or composite material with rubber padding for stability, a blue gladhand for service air brake coupling, a red gladhand with an air-blocking plug for emergency air brake coupling, a detachable air hose for linking the semi-trucks air brake system to the trailer and a blue wire for signal transmission between the truck and trailer. The device is coupled to an air-to-electric brake controller which is connected to the semi-truck's electrical system. The device is also adapted to receive a light and brake signal from the semi-truck and convert the same into a combined light signal for the trailer. By way of background, it is to be appreciated that gladhands are designed to allow the driver to disconnect without a mechanic or tools. They sometimes utilize a quick release style to speed up brake release time. A tractor/trailer typically has two gladhands one for service brakes and another for emergency brakes. Gladhands are generally color-coded, and in North America service lines are blue and emergency brake lines are red and are standardized by SAE International's standard SAE J318.

In this manner, the semi-truck to RV conversion device of the present invention accomplishes all of the foregoing objectives and provides users with a system that enables semi-trucks to tow trailers that have electric brakes. The device serves the dual purpose of maintaining the air brake connection for the truck and facilitating the conversion to electric brake signals for the trailer. The system simplifies the process of towing an RV, work, or similar trailer with a semi-truck without extensive modifications to the truck or trailer.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a braking conversion apparatus for a semi-truck and trailer. The apparatus enables semi-trucks with air brakes to tow trailers equipped with electric brakes. The apparatus further comprising an electrical enclosure, a rubber padding located on a bottom surface of the base to enhance stability, prevent sliding, and reduce vibrations. The apparatus also includes a blue service air brake gladhand and a red emergency air brake gladhand, a detachable air hose with a first end connected to the blue gladhand and a second end for connection to a disconnect point on the rear of a truck's cab, a plug disposed in an air port of the red gladhand for obstructing airflow from the red air line, and a blue wire extends from the electrical enclosure to the disconnect on the rear of the semi-trucks cab, wherein the blue wire is adapted to carry control signals for the electric brakes on the trailer.

In yet another embodiment, the electrical enclosure is T-shaped and is durable, and has a weather-resistant construction.

In another embodiment, the electrical enclosure is made of a high-strength composite material.

In yet another embodiment, a method for converting brake signals from a semi-truck to a trailer, the method executed by a brake conversion system. The method includes the steps of receiving air pressure from a blue air line connected to a blue gladhand of the conversion device, converting the received air pressure into an electrical signal using an air-to-electric brake controller powered by a 12-volt power source, transmitting the electrical signal to the electric brakes of the trailer, wherein the strength of the trailer braking is proportionate to the air pressure signal, enabling synchronized braking.

In a further embodiment of the present invention, a universal brake conversion device is disclosed. The device includes an electrical enclosure capable of being mounted on a semi-truck, a detachable air hose and a blue wire for connection to the truck's braking system, and an integrated air-to-electric brake controller system connectable via an air tube to the semi-truck.

In yet another embodiment, a semi-truck light cord plug-in is disposed on the device and a RV-style light cord plug-in is disposed on the rear of the device. The conversion box is adapted to receive the electrical signals from the semi-trucks light cord via the plug-in and to interpret and reconfigure the separate signals from the truck into a format compatible with the trailer.

In yet another embodiment, the device has at least one sensor and at least one LED disposed thereon.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the semi-truck and trailer braking conversion device of the present invention in accordance with the disclosed structure;

FIG. 2 illustrates a perspective view showing the brake conversion device mounted on a semi-truck in accordance with the disclosed structure;

FIG. 3 illustrates an enlarged view of the connection of the air and electric brake conversion device of the present invention to the cab of a truck in accordance with the disclosed architecture;

FIG. 4 illustrates a block diagram showing connection of the conversion device and an air-to-electric brake controller in accordance with the disclosed structure; and

FIG. 5 illustrates another embodiment of the semi-truck and trailer braking conversion device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a system that enables semi-trucks, which use air brakes, to tow trailers that have electric brakes. Additionally, there is a long-felt need in the art for an improved braking conversion adapter that translates the air brake signals from the truck into electrical signals that can operate the electric brakes on the trailer. Moreover, there is a long-felt need in the art for a brake conversion system that simplifies the process of towing an RV, work, or similar trailer with a semi-truck. Further, there is a long-felt need in the art for a semi-truck and trailer braking compatibility system that includes a red gladhand and a blue gladhand. Furthermore, there is a long-felt need in the art for a comprehensive conversion system designed for semi-trucks, enabling the trucks to pull trailers with electric brakes using the truck's air brakes. Finally, there is a long-felt need in the art for a conversion system that integrates air brake signals with electric brake systems and adapts the lighting systems for compatibility with RV-style trailers.

The present invention, in one exemplary embodiment, is a method for converting brake signals from a semi-truck to a trailer, the method executed by a brake conversion system. The method includes the steps of receiving air pressure from a blue air line connected to a blue gladhand of the conversion device, converting the received air pressure into an electrical signal using an air-to-electric brake controller powered by a 12-volt power source, transmitting the electrical signal to the electric brakes of the trailer, wherein the strength of the trailer braking is proportionate to the air pressure signal, enabling synchronized braking.

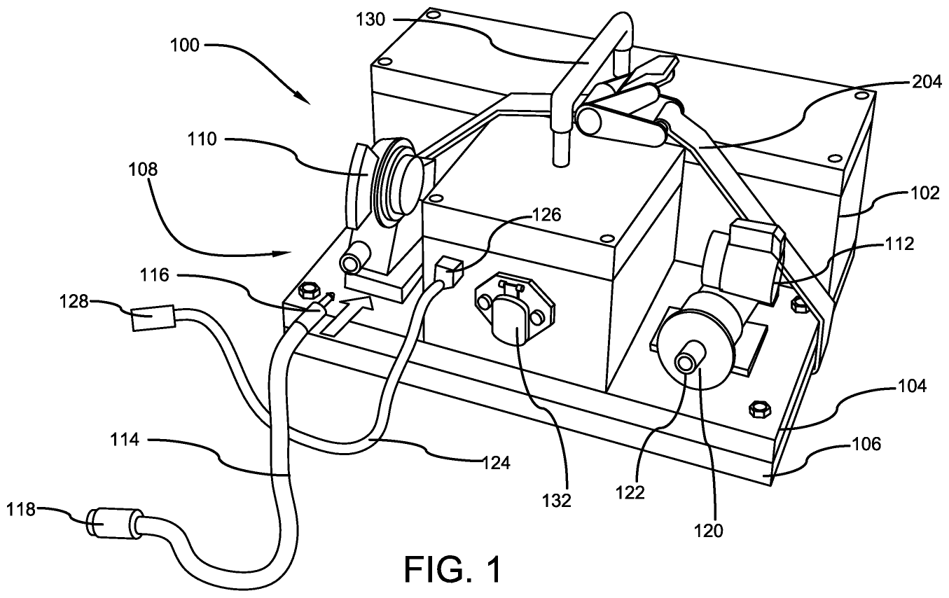

Referring initially to the drawings, FIG. 1 illustrates a perspective view of the semi-truck and trailer braking conversion device of the present invention in accordance with the disclosed structure. The semi-truck-to-trailer braking conversion device 100 is a standalone device designed to enable semi-trucks, which commonly have air brakes, to pull a trailer that uses electric brakes. The converter device 100 can be used as an aftermarket product or alternatively can be integrated during manufacturing of the semi-truck. More specifically, the device 100 includes a T-shaped electrical enclosure 102 which is durable and weatherproof. The electrical enclosure 102 is mounted on a base 104 made of steel or composite material. The base 104 has a rubber padding 106 at the bottom surface for providing stability, preventing sliding, and reducing vibrations during the running of the semi-truck in which the air-to-electric brake converter device 100 is installed.

On the front side 108, the converter device 100 includes a blue gladhand 110 and a red gladhand 112. The gladhands 110, 112 are used for linking the semi-truck air lines to the trailer for providing an efficient brake conversion. The blue gladhand 110 is the service air brake coupling and is used to apply and release the brakes during normal operation. The red gladhand 112 is the emergency air brake coupling. A detachable air hose 114 having a first end 116 and a second end 118 opposite to the first end 116 extends from the blue gladhand 110. The detachable air hose 114 is adapted to serve as a link between the blue gladhand 110 on the converter 100 and a disconnect point on the rear of the truck's cab as illustrated later in the disclosure. As explained later in the disclosure, the detachable air hose 114 facilitates the communication between the air brake systems of the truck and the trailer. Further, the hose 114 is necessary for ensuring that the trailer's brakes respond appropriately to signals from the truck's braking system.

The red gladhand 112 has a plug 120 in the air port 122 thereof for blocking air completely from the red air line. The air is blocked from the red gladhand 112 because the trailer has electric brakes and the red air line is not required for operation of the trailer brakes in accordance with the disclosed invention.

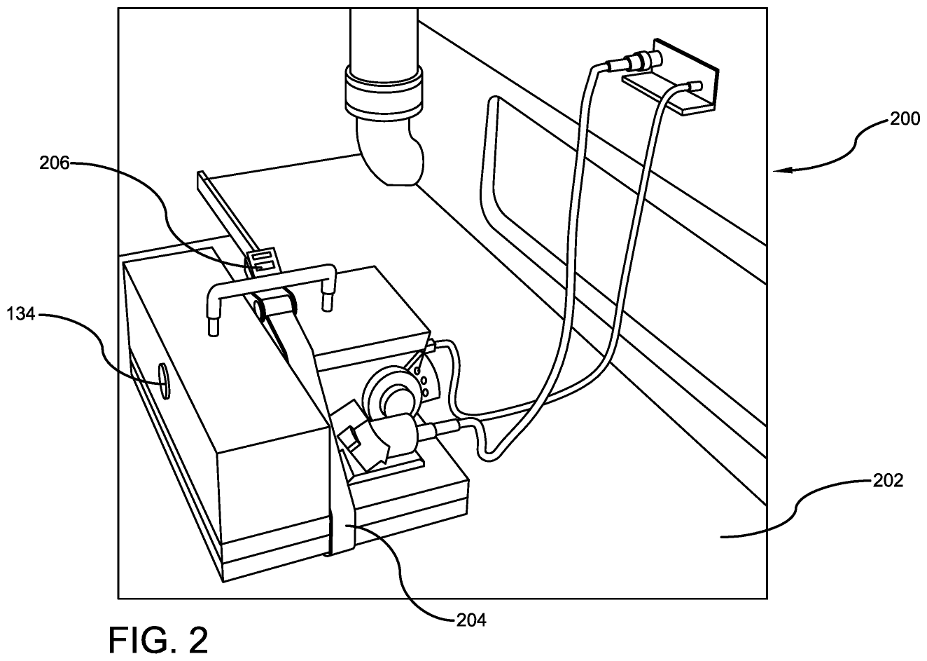

A flexible blue wire 124 extends from electrical box 100 to a disconnect on the back of the cab of the semi-truck. The blue wire 124 is adapted to transmit signals from the truck to control the electric brakes on the trailer. The blue wire 124 is connected to an air-to-electric brake controller (illustrated in FIG. 2) for providing a smooth and controlled braking operation, enhancing safety during the towing of trailers with electric brakes. The blue wire 124 is fixed to the converter box 100 using the first end 126 and has a free second end 128.

It will be apparent to a person skilled in the art that the semi-truck to RV converter 100 is a comprehensive and universal device that facilitates the compatibility between a semi-truck with air brakes and a trailer with electric brakes. The blue wire 124 serves as the communication channel for controlling the electric brakes on the trailer and the detachable air hose 114 from the blue gladhand 110 links the air brake systems of the truck and the trailer. The converter box 100 includes an integrated handle 130 for easy handling and transportation of the box 100.

FIG. 2 illustrates a perspective view showing the brake conversion device mounted on a semi-truck in accordance with the disclosed structure. The device 100 is permanently or removably attached to an appropriate position such as a catwalk 202 of the semi-truck 200. The rubber padding 106 prevents the device 100 from sliding even when there is vibration and movement in the semi-truck 200. For providing additional security to the device 100 during installation, an adjustable ratchet-type strap 204 is secured and fastened. The strap 204 is adjustable and can be secured using a fastener 206 such as a snap-fastener or any other conventional fastener.

Referring again to FIGS. 1 and 2, a semi-truck light cord plug-in or electrical outlet 132 is disposed on the device 100 for receiving electrical power and signals from the truck, and an RV-style light cord plug-in 134 is disposed on the rear of the device 100 for distributing electrical power and signals to the trailer. The conversion box 100 is adapted to receive the electrical signals from the semi-trucks light cord via the plug-in 132, interprets and reconfigures the separate signals from the truck into a format compatible with the trailer. After processing and reconfiguration, the device 100 sends the combined signals to the trailer's lighting system.

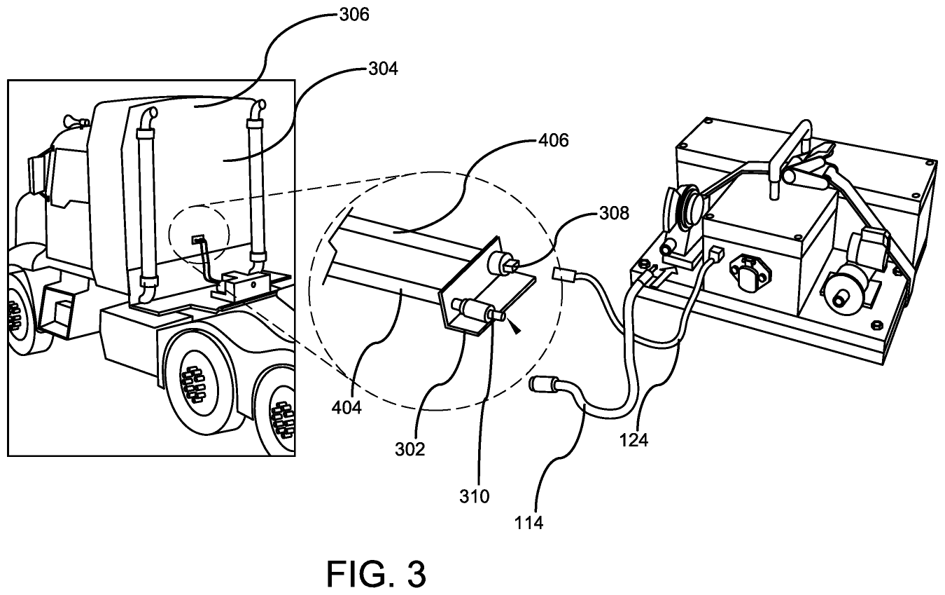

FIG. 3 illustrates an enlarged view of the connection of the air and electric brake conversion device of the present invention to the cab of a truck in accordance with the disclosed architecture. As illustrated, the detachable air hose 114 is connected to a port 308 of the disconnect 302 on the rear 304 of the truck's cab 306. The blue wire 124 is connected to another port 310 of the disconnect 302.

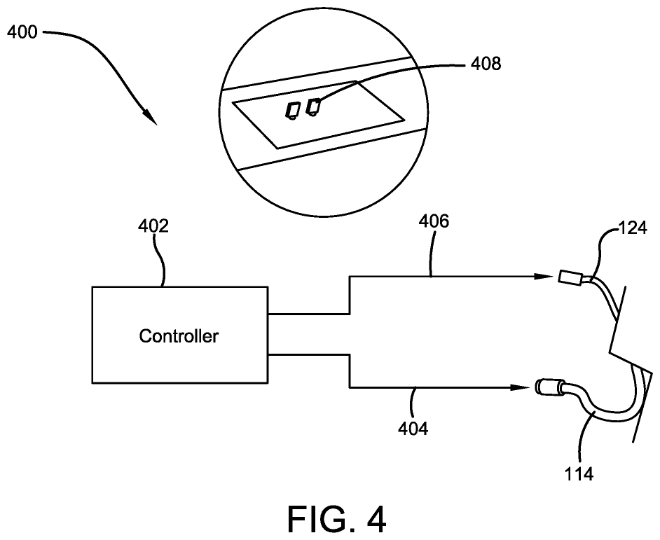

Referring now to FIGS. 3 and 4, the device 100 works in conjunction with an air-to-electric brake controller 402, and both of them together can form the air-to-electric brake controller system 400. The controller 402 is connected to the truck's blue wire 404 which is coupled to air hose 114 of the device 100. The controller also has a ¼″ air tube 406 attached to the disconnect on the rear of the cab. The brake controller 402 is powered by plugging into a cigarette lighter port 408, which provides a 12-volt power source for the operation of the brake controller 402.

In use, when a truck driver applies the brakes, air is pushed through the truck's braking system (not shown). The air travels through the blue air line 114, which is connected to the blue gladhand on the semi to the RV converter device 100. The air actuated brake controller 402 inside the cab 306 receives the air pressure of the air and converts the air pressure into an electrical signal. The electrical signal is then sent back through the blue wire 404 and to the electrical brakes of the trailer. The electric brakes on the trailer apply the brakes based on the received electrical signal. In one exemplary embodiment, the strength of the braking in the trailer is proportionate to the air pressure signal converted by the controller 402, allowing for synchronized braking between the truck and the trailer.

It should be noted that the air-to-electric brake controller system 400 enables semi-trucks to tow RV-style trailers with electric brakes. The air-to-electric brake device 100 is easy to install and remove, enabling quick transitions between hauling semi-trailers and RV trailers. The semi-truck to RV brake conversion system 400 improves the overall safety of the truck-trailer combination, especially during deceleration and stopping.

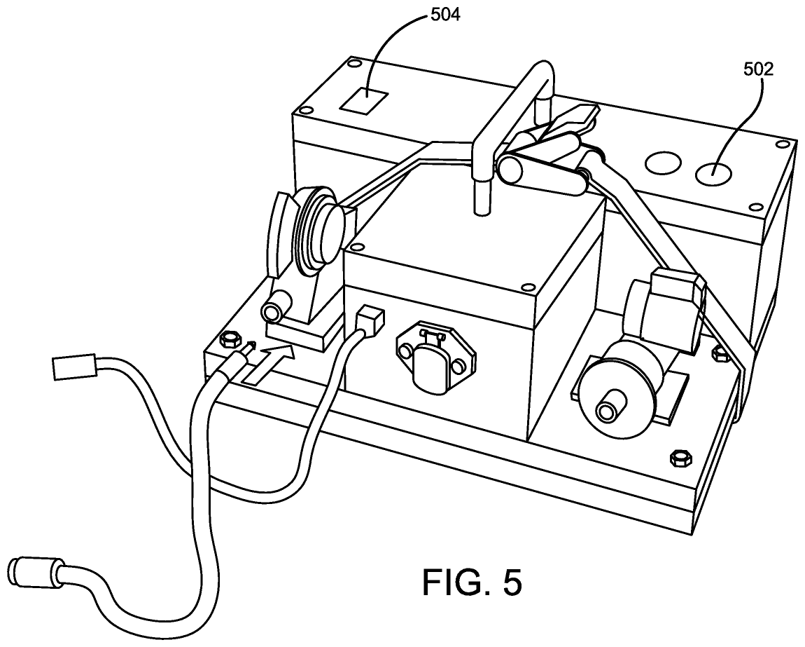

As illustrated in FIG. 5, in some embodiments, one or more diagnostic LEDs 502 may be disposed on the converter box 100 to indicate the status of the electrical connections of the box 100. A sensor 504 can be included in the converter box 100 that automatically disconnects the trailer brakes in a controlled manner if the trailer becomes detached from the truck.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “semi-truck and trailer braking conversion device”, “air-to-electric brake converter device”, “converter device”, “converter box”, and “device” are interchangeable and refer to the semi-truck and trailer braking conversion device 100 of the present invention. Similarly, as used herein, “air-to-electric brake controller system”, “semi-truck to RV brake conversion system”, and “system” are interchangeable and refer to the air-to-electric brake controller system 400 of the present invention.

Notwithstanding the foregoing, the semi-truck and trailer braking conversion device 100 and the air-to-electric brake controller system 400 of the present invention can be of any suitable size and configuration as is known in the art without affecting the overall concept of the invention, provided that they accomplish the above-stated objectives. One of ordinary skill in the art will appreciate that the semi-truck and trailer braking conversion device 100 and the air-to-electric brake controller system 400 as shown in the FIGS. are for illustrative purposes only, and that many other sizes and shapes of the semi-truck and trailer braking conversion device 100 and the air-to-electric brake controller system 400 are well within the scope of the present disclosure. Although the dimensions of the semi-truck and trailer braking conversion device 100 and the air-to-electric brake controller system 400 are important design parameters for user convenience, the semi-truck and trailer braking conversion device 100 and the air-to-electric brake controller system 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A truck to trailer braking conversion device comprising:
a converter;
an electrical enclosure;
a first gladhand;
a second gladhand;
a detachable air hose having a first end and a second end;
an electrical wire connection having a first end and a second end;
wherein said truck having air brakes;
wherein said trailer having electric brakes;
wherein said first end of said detachable air hose selectively connected to said first gladhand;
wherein said second end of said detachable air hose selectively connected to a first disconnect on a rear of said truck for linking an air line of said truck to said first gladhand;
wherein said first end of said electrical wire connection connected to said converter;
wherein said second end of said electrical wire connection selectively connected to a second disconnect on the rear of said truck for linking signals from said truck to said converter;
wherein said converter having an air-to-electric brake controller; and
further wherein said first gladhand having a service air brake coupling for signaling applying and releasing said electric brakes of said trailer.

2. The truck to trailer braking conversion device of claim 1, wherein said second gladhand having an emergency air brake coupling.

3. The truck to trailer braking conversion device of claim 2, wherein said second gladhand having a plug-in air port for selectively blocking air from said second gladhand.

4. The truck to trailer braking conversion device of claim 3, wherein said first gladhand is a blue gladhand.

5. The truck to trailer braking conversion device of claim 4, wherein said second gladhand is a red gladhand.

6. The truck to trailer braking conversion device of claim 5, wherein said enclosure is waterproof including a padded bottom surface.

7. The truck to trailer braking conversion device of claim 6, wherein said converter having a first electrical outlet for receiving electrical signals from said truck and a second electrical outlet for distributing said electrical signals to said trailer.

8. A truck to trailer braking conversion device comprising:
a converter;
an electrical enclosure;
a first gladhand;
a second gladhand;
a detachable air hose having a first end and a second end;
an electrical wire connection having a first end and a second end;
wherein said truck having an air-to-electric brake controller electrically powered by said truck;
wherein said air-to-brake controller having a first air line and a first connector for connecting to said electrical wire connection and a second connector for connecting to said detachable air hose;
wherein said truck having air brakes;
wherein said trailer having electric brakes;
wherein said first end of said detachable air hose selectively connected to said first gladhand;
wherein said second end of said detachable air hose selectively connected to said air-to-brake controller;
wherein said first end of said electrical wire connection connected to said converter;
wherein said second end of said electrical wire connection selectively connected to said first connector of said air-to-brake controller;
wherein said air-to-brake controller actuated with air pushed through said air brakes of said truck; and
further wherein said actuation of said air-to-brake controller signals said first gladhand to apply and release said electric brakes of said trailer in accordance with said air brakes of said truck for synchronized braking between said truck and said trailer.

9. The truck to trailer braking conversion device of claim 8, wherein said second gladhand having an emergency air brake coupling.

10. The truck to trailer braking conversion device of claim 9, wherein said second gladhand having a plug-in air port for selectively blocking air from said second gladhand.

11. The truck to trailer braking conversion device of claim 10, wherein said enclosure is waterproof including a padded bottom surface.

12. The truck to trailer braking conversion device of claim 8, wherein said converter having a first electrical outlet for receiving electrical signals from said truck and a second electrical outlet for distributing said electrical signals to said trailer.

13. A truck to trailer braking conversion device comprising:
a converter;
an electrical enclosure;
a first gladhand;
a detachable air hose having a first end and a second end;
an electrical wire connection having a first end and a second end;
wherein said truck having an air-to-electric brake controller electrically powered by said truck;
wherein said air-to-brake controller having a first air line and a first connector for connecting to said electrical wire connection and a second connector for connecting to said detachable air hose;
wherein said truck having an air braking system;
wherein said trailer having an electric braking system;
wherein said first end of said detachable air hose selectively connected to said first gladhand;
wherein said second end of said detachable air hose selectively connected to said air-to-brake controller;
wherein said first end of said electrical wire connection connected to said converter;
wherein said second end of said electrical wire connection selectively connected to said first connector of said air-to-brake controller;
wherein said air-to-brake controller actuated with air pushed through said air braking system; and
further wherein said actuation of said air-to-brake controller signals said first gladhand to apply and release said electric braking system of said trailer in proportion to said air braking system.

14. The truck to trailer braking conversion device of claim 13, wherein said proportion having synchronized braking between said truck and said trailer.

15. The truck to trailer braking conversion device of claim 13 further comprising a second gladhand wherein said second gladhand having an emergency air brake coupling.

16. The truck to trailer braking conversion device of claim 15, wherein said second gladhand having a plug-in air port for selectively blocking air from said second gladhand.

17. The truck to trailer braking conversion device of claim 13, wherein said first gladhand is a blue gladhand.

18. The truck to trailer braking conversion device of claim 17, wherein said second gladhand is a red gladhand.

19. The truck to trailer braking conversion device of claim 18, wherein said enclosure is waterproof including a padded bottom surface.

20. The truck to trailer braking conversion device of claim 13, wherein said converter having a first electrical outlet for receiving electrical signals from said truck and a second electrical outlet for distributing said electrical signals to said trailer.
